(19) United States
(12) Patent Application Publication
(10) Pub. No.: US 2014/0310074 A1
(43) Pub. Date: Oct. 16, 2014

(54) APPARATUS FOR INFRASTRUCTURE-FREE ROADWAY TOLLING

(71) Applicant: Amtech Systems, LLC, Albuquerque, NM (US)

(72) Inventor: Kelly Gravelle, Poway, CA (US)

(73) Assignee: Amtech Systems, LLC, Albuquerque, NM (US)

(21) Appl. No.: 14/249,997

(22) Filed: Apr. 10, 2014

Related U.S. Application Data
(60) Provisional application No. 61/811,490, filed on Apr. 12, 2013.

(51) Int. Cl. G07B 15/06; B60R 11/02; H04M 1/725

(52) U.S. Cl. CPC G07B 15/063; H04M 1/72572; B60R 11/0241; B60R 2011/0294
USPC 705/13

(57) ABSTRACT

A system is disclosed for relaying vehicle location and lane position on a multiple lane roadway to a central office for tolling purposes. The system has an on board unit comprising a GPS receiver, and a cellular telephone comprising a camera and a computer. The on board unit tracks vehicle location. The cellular telephone is mounted in the vehicle such that its camera can photograph the roadway. The on board unit transmits vehicle position information to the cellular phone and the cellular phone transmits position information relative to fixed geo-data and lane information to the central office.

### CROSS-REFERENCE TO RELATED APPLICATIONS

This utility application claims the benefit under 35 U.S.C. §119(e) of Provisional Application Ser. No. 61/811,490, filed on Apr. 12, 2013, entitled Apparatus for Infrastructure-free Roadway Tolling. The entire disclosure of this application is incorporated by reference herein.

### FIELD OF THE INVENTION

The invention relates generally to the field of vehicle tracking and tolling and particularly to determination of lane of travel of a vehicle.

### BACKGROUND

In the vehicle tolling field, low or no infrastructure systems and methods are being considered by service providers and highway agencies. Tolling systems that require little or no roadway equipment allow for rapid deployment of tolling schemes and can make concepts like congestion-pricing possible by charging tolls for roads that traditionally were not toll roads.

In the development of infrastructure-free tolling (IFT) concepts for a new way to deploy a High-Occupancy Toll lane (HOT) system the inventor considered using a smart phone to implement HOT and perhaps even IFT based tolling on traditional fee for use toll facilities.

The idea has appeal in that the cost of the hardware is already sunk by the consumer and the cost of data service might be folded into existing customer data plans provided the data requirements are modest. However two problems exist in offering a HOT smart phone application. First, cell phone batteries die quickly with heavy GPS usage, reducing the appeal to consumers and potential operational complexities associated with lots of dead batteries. Second, is the design of a practical method of enforcement. Vehicle tracking over a common carrier might work in concept, but it would require much higher data usage to “breadcrumb” i.e. track the vehicle's course and expensive equipment in police vehicles to enforce. Latency of messaging in common carrier networks is not guaranteed and may be too slow to offer a practical enforcement approach.

The inventor has made related disclosures in U.S. patent application Ser. No. 13/398,337 filed on Feb. 16, 2012, the entire disclosure of which is incorporated by reference herein.

### DESCRIPTION OF THE DRAWINGS

FIG. 1 is a block diagram of an exemplary system for infrastructure-free roadway tolling.

### SUMMARY OF THE INVENTION

A system is disclosed for relaying vehicle location and lane position on a multiple lane roadway to a central office for tolling purposes. The system includes: an on board unit comprising a GPS receiver, and a cellular telephone comprising a camera and a computer, wherein, the on board unit is configured to track vehicle location, the cellular telephone is mounted in the vehicle such that the camera can photograph the roadway, the on board unit transmits said vehicle location to the cellular phone and the cellular phone transmits vehicle information relative to fixed geo-data and lane information to the central office. In a further embodiment of this system, the on board unit has data memory containing fixed location data and is configured to compare GPS data of current vehicle location to said fixed location data. In a further embodiment of this system, the cellular telephone has data memory containing fixed location data and is configured to compare GPS data of current vehicle location to said fixed location data.

In a further embodiment of this system, there is included a low power RF transceiver for transmitting toll-related data relating to monitoring equipment located remotely from the vehicle. In a further embodiment of this system, the transmission of vehicle location to said cellular telephone is via a Bluetooth® compatible wireless data link. In a further embodiment of this system, the low power RF transceiver is a Bluetooth®-compatible transceiver. In a further embodiment of this system, the cellular telephone is configured to determine a lane of travel based on a photograph of the roadway. In a further embodiment of this system, the lane information comprises a photograph made with said camera and wherein a lane of travel is determined at said back office.

In a further embodiment of this system, the cellular telephone is further configured to accept user input of vehicle occupancy or lane of travel, and to transmit said user input to the back office. In a further embodiment of this system, either the on board unit or the cellular telephone transmits the user information to an enforcement receiver.

An infrastructure-free multi-lane roadway tolling system is also disclosed. The system includes: an on board unit comprising a GPS receiver and a low power RF transceiver; a cellular telephone comprising a camera and a computer; a back office data center configured to receive data from the cellular telephone via a cellular phone network; and an enforcement receiver located on or near the roadway and configured to receive data from the on-board unit or the cellular telephone. The on board unit is configured to track vehicle location, the cellular telephone is mounted in the vehicle such that the camera can photograph the roadway, the on board unit transmits the vehicle location to the cellular phone; the cellular phone transmits vehicle information relative to fixed geo-data and lane information to the back office data center via a cellular telephone network; and either the cellular telephone or the on board unit is configured to transmit information to the enforcement receiver. In a further embodiment of this system, the on board unit has data memory containing fixed location data and is configured to compare GPS data of current vehicle location to said fixed location data. In a further embodiment of this system, the cellular telephone has data memory containing fixed location data and is configured to compare GPS data of current vehicle location to said fixed location data. In a further embodiment of this system, the low power RF transceiver is configured to transmit toll-related data relating to said enforcement receiver. In a further embodiment of this system, the transmission of vehicle location to said cellular telephone is via a Bluetooth® compatible wireless data link. In a further embodiment of this system, the low power RF transceiver is a Bluetooth®-compatible transceiver. In a further embodiment of this system, the cellular telephone is configured to determine a lane of travel based on a photograph of the roadway. In a further embodiment of this system, the lane information comprises a photograph made with the camera and wherein the back office data center is configure to determine a lane of travel based on the photograph.

### DETAILED SPECIFICATION

TransCore's® ROVR concept was designed to solve the two problems outlined above. In the ROVR system (described in application Ser. No. 13/398,337), GPS is powered by a convenient standard vehicle port (the OBD port) as is a local low power radio that can transmit with very low latency the data needed by police for enforcement, with a simple and inexpensive enforcement module that is about 5×2.5×⅓ inches and can fit in any glove compartment.

A user interface module (UIM) also communicates to ROVR via the local radio interface and provides an easy-to-use module. Because GPS technology cannot today provide reliable lane resolution positioning, the user not only self declares occupancy, but also self declares lane usage by pressing a single switch.

The inventor has also recognized that a smart phone could fill the role of a user interface to the onboard tolling equipment, however there are concerns that this is not the safest interface to use when the vehicle is in motion as required by the self-declaration of usage paradigm. A simple switch operation is safer than using the phone as a user interface because the switch is similar to many other functions of vehicle operation such as operating windshield wipers or turning on the radio. However, if the lane level resolution can be attained such that user interaction in motion is not required the smart phone application becomes more viable. If the GPS power draw on the cell phone can also be addressed as well a smart phone app becomes much more viable.

A new concept for lane determination has been previously proposed to add an imager that can take photos of the view outside the vehicle that can be processed to determine lane and that this would be done by adding an imager to the UIM or by using a smart phone with a built in camera. That disclosure is titled System and Method for In-Vehicle Lane Determination Using CMOS Image Sensor, was filed as a provisional application on Jun. 8, 2012 and bears U.S. Patent Application Ser. No. 61/649,853 and is incorporated by reference herein. A non-provisional application claiming priority to application Ser. No. 61/649,853 was filed on May 21, 2013 and bears application Ser. No. 13/899,389, and is incorporated by reference herein.

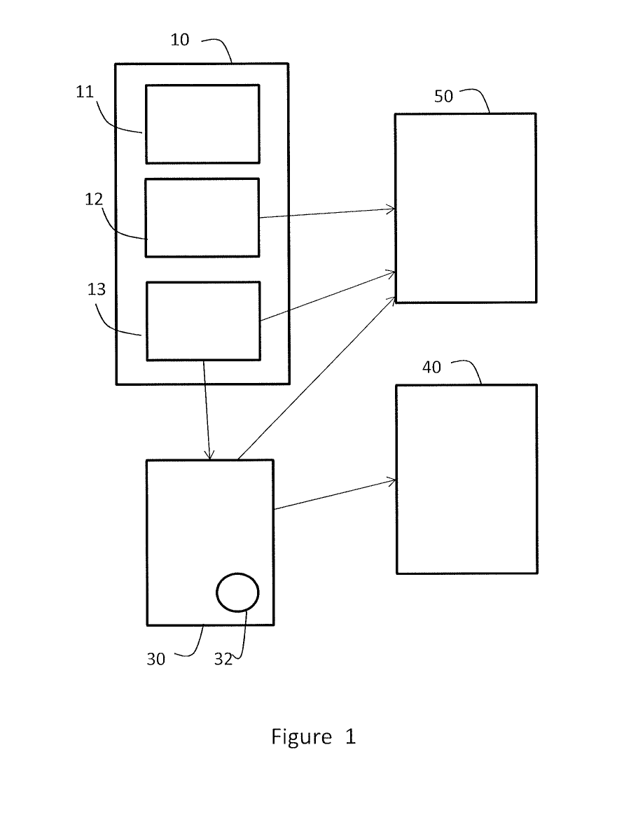

With reference to FIG. 1, and to overcome the aforementioned GPS power draw problem, a location monitoring unit (LMU) 10 having a GPS 11 and low power radio 12, which can be a Bluetooth® transceiver or the LMU can include a separate Bluetooth® transceiver 13, would still be provided that is powered by vehicle power and communicates with the phone 30 over the Bluetooth® connection. The LMU 10 would then use the phone hardware and the user's cell phone data plan for over the air connectivity to a back office 40, so that no cell phone hardware would be required in the LMU. The LMU could be in the form of an OBD port mounted device, a cell phone cradle, or a device that runs off the standard 12 VDC power port, or a USB connector present in many newer vehicles. A USB form factor could also be used for the LMU in conjunction with a power adaptor to either the standard 12 VDC power connector or the OBD port for maximum flexibility. The phone would be positioned at a standard attitude in the car such as in the center of the front dash or on the front windshield with dual lock (a 3M product similar to Velcro®) or in a transparent sleeve. This is done to set the smart phone positioned with its camera 32 looking out of vehicle front window.

The smart phone concept involves developing a HOT application that works in similar fashion to ROVR. In the existing ROVR system geo-zones are stored on the vehicle equipment and reported when intersected. In the system using a cell phone, the geo-zone information can be stored in the cell phone and the LMU reports position to the cell phone and the cell phone make a comparison between current position and stored information and reports over the cellular network when a geo-zone is intersected, or the data can be stored and comparison made in the LMU, which reports to the cell phone to make the transmission over the cellular network to a back office.

The LMU provides periodic or continuous GPS data to the smart phone over the Bluetooth® link, or alternatively geo-zone intersections. When a toll zone is intersected as determined by the stored geo-zone function, one or more photos are taken by the cell phone of the view out of the windshield. These photos can be processed (either on the smart phone or sent to a back office) to determine how many lanes over the vehicle is from the median, thus determining without user intervention whether the vehicle is actually in the designated HOT lane. Visual cues can be lane lines diamond symbols, signage present by convenience or even signage place deliberately. Deliberate signage on sign bridges could be a very light infrastructure solution based on a smart phone application.

The described embodiment solves the lane resolution problem and makes a smart phone a viable user interface device. That leaves the enforcement problem. This can be addressed by Bluetooth® -enabling the aforementioned cradle or LMU to talk to the smart phone application to verify proper operation, then provide enforcement data including vehicle description and license plate number and operating status over the enforcement radio link to an enforcement receiver 50. This disclosed in the aforementioned Ser. No. 13/298,337 application. This provides a highly viable and enforceable IFT tolling and HOT concept. The cradle would be much less costly than an LMU. In an embodiment, the Bluetooth® radio 13 is used directly as the enforcement radio link as described above. Typically the Bluetooth® links are not engineered with enough range or fast connect time and using Bluetooth® for this function may cause interference or connectivity problems with either the LMU. However, more advanced Bluetooth® versions are being developed and if these issues are overcome by advancing technology, Bluetooth® may become a viable enforcement link as described above.

The smart phone acts as an interface to select the number of occupants using touch screen buttons, including motion lock outs to make sure information is only inputted by the user with the vehicle stopped to ensure safe operation.

1. A system for relaying vehicle location and lane position on a multiple lane roadway to a central office for tolling purposes, comprising:
an on board unit comprising a GPS receiver, and
a cellular telephone comprising a camera and a computer,
wherein, said on board unit is configured to track vehicle location, said cellular telephone is mounted in the vehicle such that said camera can photograph the roadway, said on board unit transmits said vehicle location to said cellular phone and said cellular phone transmits vehicle information relative to fixed geo-data and lane information to the central office.

2. The system of claim 1, wherein said on board unit has data memory containing fixed location data and is configured to compare GPS data of current vehicle location to said fixed location data.

3. The system of claim 1, wherein said cellular telephone has data memory containing fixed location data and is configured to compare GPS data of current vehicle location to said fixed location data.

4. The system of claim 1, further comprising a low power RF transceiver for transmitting toll-related data relating to monitoring equipment located remotely from the vehicle.

5. The system of claim 1, wherein said transmission of vehicle location to said cellular telephone is via a Bluetooth® compatible wireless data link.

6. The system of claim 4, wherein said low power RF transceiver is a Bluetooth®-compatible transceiver.

7. The system of claim 1, wherein said cellular telephone is configured to determine a lane of travel based on a photograph of the roadway.

8. The system of claim 1, wherein said lane information comprises a photograph made with said camera and wherein a lane of travel is determined at said back office.

9. The system of claim 1, wherein said cellular telephone is further configured to accept user input of vehicle occupancy or lane of travel, and to transmit said user input to said back office.

10. The system of claim 9, wherein either said on board unit or said cellular telephone transmits said user information to an enforcement receiver.

11. An infrastructure-free multi-lane roadway tolling system comprising:
an on board unit comprising a GPS receiver and a low power RF transceiver;
a cellular telephone comprising a camera and a computer;
a back office data center configured to receive data from said cellular telephone via a cellular phone network; and
an enforcement receiver located on or near said roadway and configured to receive data from said on-board unit or said cellular telephone
wherein, said on board unit is configured to track vehicle location, said cellular telephone is mounted in the vehicle such that said camera can photograph the roadway, said on board unit transmits said vehicle location to said cellular phone; said cellular phone transmits vehicle information relative to fixed geo-data and lane information to said back office data center via a cellular telephone network; and either said cellular telephone or said on board unit is configured to transmit information to said enforcement receiver.

12. The system of claim 11, wherein said on board unit has data memory containing fixed location data and is configured to compare GPS data of current vehicle location to said fixed location data.

13. The system of claim 11, wherein said cellular telephone has data memory containing fixed location data and is configured to compare GPS data of current vehicle location to said fixed location data.

14. The system of claim 11, wherein said low power RF transceiver is configured to transmit toll-related data relating to said enforcement receiver.

15. The system of claim 11, wherein said transmission of vehicle location to said cellular telephone is via a Bluetooth® compatible wireless data link.

16. The system of claim 11, wherein said low power RF transceiver is a Bluetooth® compatible transceiver.

17. The system of claim 11, wherein said cellular telephone is configured to determine a lane of travel based on a photograph of the roadway.

18. The system of claim 11, wherein said lane information comprises a photograph made with said camera and wherein said back office data center is configure to determine a lane of travel based on said photograph.

19. The system of claim 11, wherein said cellular telephone is further configured to accept user input of vehicle occupancy or lane of travel, and to transmit said user input to said back office data center.

20. The system of claim 11, wherein said cellular telephone is further configured to accept user input of vehicle occupancy or lane of travel and to transmit said user input to said enforcement receiver.
